(19) United States
(12) Patent Application Publication
(10) Pub. No.: US 2026/0247436 A1
(43) Pub. Date: Aug. 20, 2026

(54) CONCENTRATORS, COMMUNICATION SYSTEMS, CONTROL METHODS AND PROGRAMS

(71) Applicant: NTT, Inc., Tokyo (JP)

(72) Inventors: Hirotaka UJIKAWA, Musashino-shi (JP); Yuka OKAMOTO, Musashino-shi (JP); Yoshihito SAKAI, Musashino-shi (JP); Tatsuya SHIMADA, Musashino-shi (JP)

(73) Assignee: NTT, Inc., Tokyo (JP)

(21) Appl. No.: 18/872,320

(22) PCT Filed: Jun. 13, 2022
(86) PCT No.: PCT/JP2022/023653

§ 371 Date: Dec. 6, 2024

(51) Int. Cl. H04W 74/0816; H04W 28/02

(52) U.S. Cl. CPC H04W 74/0816; H04W 28/0289

(57) ABSTRACT

One aspect of the present invention is a concentrator that receives streams transmitted from a plurality of transmission terminals, the concentrator includes a first derivation unit that derives transmission start timing in which the streams transmitted from the plurality of transmission terminals are grouped in advance and reception periods of a packet group included in the streams belonging to the group do not overlap in the group, a second derivation unit that derives transmission start timing in which reception periods of packet groups transmitted at the transmission start timing derived by the first derivation unit do not overlap in different groups, and an instruction unit that instructs the transmission terminal on the transmission start timing derived by the second derivation unit.

### TECHNICAL FIELD

The present invention relates to a technique of a concentrator, a communication system, a control method, and a program.

### BACKGROUND ART

Since a wireless scheduling (Proportional Fair) used in the prior art impartially assigns a band to a transmission terminal, even when burst traffic such as video traffic is transmitted, it alternately gives transmission permission to a plurality of transmission terminals. Here, “burst” means that a generation of transmitted data does not continue for a long time, but a data amount at the time of generation is large.

### CITATION LIST

### Non Patent Literature

[NPL 1] “(4) High-efficiency Packet Access Technology on Data Link Layer/Physical Layer”, NTT DOCOMO Technical Journal, VOL. 11 No. 2. https://www.docomo.ne.jp/binary/pdf/corporate/technology/rd/technical_journal/bn/vol11_2/vol11_2_032jp.pdf

[NPL 2] IETF RFC 3550, “RTP: A Transport Protocol for Real-Time Applications”. https://www.rfc-editor.org/rfc/rfc3550.txt

[NPL 3] IETF RFC6679, “Explicit Congestion Notification (ECN) for RTP over UDP”. https://www.rfc-editor.org/rfc/rfc6679.txt

### SUMMARY OF INVENTION

### Technical Problem

FIG. 1 is a block diagram showing a configuration example of a communication system. The communication system includes a plurality of transmission terminals and a reception terminal. The plurality of transmission terminals and the reception terminal are connected via a communication network. A bottleneck link exists in the communication network.

FIG. 2 and FIG. 3 show a situation in which data transmission timing from the plurality of transmission terminals is substantially the same. FIG. 2 shows a time change in the data amount transmitted from the plurality of transmission terminals. FIG. 3 shows the time change of a queue length in a node in the communication network. The transmission data amount in the communication network repeats an increase and a decrease, and the queue length in the node also repeats the increase and the decrease. Therefore, there is a possibility that congestion occurs instantaneously, but the communication network is not congested on average.

According to a conventional ECN, a node in the communication network monitors the queue length and detects congestion. However, as shown in FIG. 3, depending on the queue length monitoring timing, the queue length increases, that is, there is a possibility that congestion cannot be detected. In addition, although the communication network is not congested on average, if a transmission rate is decreased by notifying a congestion occurrence each time the queue length exceeds a threshold value, the transmission rate is declined more than necessary. This means a decline in network utilization efficiency. Further, there is a possibility that data quality (for example, video quality) originally required by the application cannot be achieved.

Thus, when the transmission timing of video traffic from the plurality of transmission terminals overlaps, there is a problem that a large scheduling delay occurs before data constituting one image is completely transmitted.

In view of the above circumstances, an object of the present invention is to provide a technique capable of suppressing congestion on a communication network while reducing a decline in a transmission rate.

### Solution to Problem

One aspect of the present invention is a concentrator that receives streams transmitted from a plurality of transmission terminals, the concentrator includes a first derivation unit that derives transmission start timing in which the streams transmitted from the plurality of transmission terminals are grouped in advance and reception periods of a packet group included in the streams belonging to the group do not overlap in the group, a second derivation unit that derives transmission start timing in which reception periods of packet groups transmitted at the transmission start timing derived by the first derivation unit do not overlap in different groups, and an instruction unit that instructs the transmission terminal on the transmission start timing derived by the second derivation unit.

One aspect of the present invention is a communication system including a plurality of transmission terminals and a concentrator that receives streams transmitted from the transmission terminals, wherein the concentrator includes a first derivation unit that derives transmission start timing in which the streams transmitted from the plurality of transmission terminals are grouped in advance and reception periods of a packet group included in the streams belonging to the group do not overlap in the group, a second derivation unit that derives transmission start timing in which reception periods of packet groups transmitted at the transmission start timing derived by the first derivation unit do not overlap in different groups, and an instruction unit that instructs the transmission terminal on the transmission start timing derived by the second derivation unit, and the transmission terminal starts transmission at the transmission start timing instructed by the instruction unit.

One aspect of the present invention is a communication system including a concentrator that receives streams transmitted from a plurality of transmission terminals and a congestion control device, wherein the congestion control device includes a first derivation unit that derives transmission start timing in which the streams transmitted from the plurality of transmission terminals and received by the concentrator are grouped in advance and reception periods of a packet group included in the streams belonging to the group do not overlap in the group, a second derivation unit that derives transmission start timing in which reception periods of packet groups transmitted at the transmission start timing derived by the first derivation unit do not overlap in different groups, and an instruction unit that instructs the transmission terminal on the transmission start timing derived by the second derivation unit.

One aspect of the present invention is a control method of a concentrator that receives streams transmitted from a plurality of transmission terminals, the control method includes a first derivation step of deriving transmission start timing in which streams transmitted from the plurality of transmission terminals are grouped in advance and reception periods of a packet group included in streams belonging to the group do not overlap in the group, a second derivation step of deriving transmission start timing in which reception periods of packet groups transmitted at the transmission start timing derived in the first derivation step does not overlap in different groups, and an instruction step of instructing the transmission terminal on the transmission start timing derived in the second derivation step.

One aspect of the present invention is a program for causing a computer to function as a concentrator that receives streams transmitted from a plurality of transmission terminals, the program causes the computer to function as a first derivation unit that derives transmission start timing in which the streams transmitted from the plurality of transmission terminals are grouped in advance and reception periods of a packet group included in the streams belonging to the group do not overlap in the group, a second derivation unit that derives transmission start timing in which reception periods of packet groups transmitted at the transmission start timing derived by the first derivation unit do not overlap in different groups, and an instruction unit that instructs the transmission terminal on the transmission start timing derived by the second derivation unit.

### Advantageous Effects of Invention

According to the present invention, congestion in the communication network can be suppressed while reducing the decline in the transmission rate.

### BRIEF DESCRIPTION OF DRAWINGS

FIG. 1 is a block diagram showing a configuration example of a communication system.

FIG. 2 is a timing chart for explaining a problem.

FIG. 3 is a timing chart for explaining the problem.

FIG. 4 is a block diagram schematically showing a configuration example of the communication system according to an embodiment of the present invention.

FIG. 5 is a conceptual diagram for explaining one stream received by a concentrator according to the embodiment of the present invention.

FIG. 6 is a conceptual diagram for explaining an overview of congestion control according to the embodiment of the present invention.

FIG. 7 is a conceptual diagram for explaining an overview of congestion control according to the embodiment of the present invention.

FIG. 8 is a block diagram schematically showing a configuration example of the concentrator according to the embodiment of the present invention.

FIG. 9 is a diagram showing a hardware configuration example of a congestion controller according to the embodiment of the present invention.

FIG. 10 is a block diagram showing a functional configuration example of the congestion controller according to the embodiment of the present invention.

FIG. 11 is a conceptual diagram showing one example of a stream identification table according to the embodiment of the present invention.

FIG. 12 is a flowchart showing one example of stream information acquisition processing according to the embodiment of the present invention.

FIG. 13 is a conceptual diagram for explaining one example of the stream information acquisition processing according to the embodiment of the present invention.

FIG. 14 is a conceptual diagram for explaining a modification example of the stream information acquisition processing according to the embodiment of the present invention.

FIG. 15 is a flowchart showing processing related to feedback control processing according to the embodiment of the present invention.

FIG. 16 is a conceptual diagram for explaining one example of overlap judgement processing according to the embodiment of the present invention.

FIG. 17 is a flowchart showing a first example of the feedback control processing according to the embodiment of the present invention.

FIG. 18 is a conceptual diagram showing one example of a feedback control table according to the embodiment of the present invention.

FIG. 19 is a flowchart showing a second example of the feedback control processing according to the embodiment of the present invention.

FIG. 20 is a conceptual diagram showing other examples of the feedback control table according to the embodiment of the present invention.

FIG. 21 is a conceptual diagram for explaining a third example of the feedback control processing according to the embodiment of the present invention.

FIG. 22 is a conceptual diagram showing one example of the stream identification table according to the embodiment of the present invention.

FIG. 23 is a conceptual diagram showing one example of a stream band table according to the embodiment of the present invention.

FIG. 24 is a flowchart showing the third example of the feedback control processing according to the embodiment of the present invention.

FIG. 25 is a conceptual diagram for explaining an application example of the concentrator according to the embodiment of the present invention.

FIG. 26 is a diagram showing a configuration example of a congestion control program in the application example of the concentrator.

FIG. 27 is a diagram showing one example of the stream identification table.

FIG. 28 is a diagram showing one example of the feedback control table.

FIG. 29 is a flowchart showing a flow of processing of the congestion control program.

FIG. 30 is a flowchart showing a flow of the processing of the congestion control program.

FIG. 31 is a diagram showing a configuration example of a feedback control unit according to a second embodiment.

FIG. 32 is a diagram showing a derivation example of a first feedback unit and a second feedback unit.

FIG. 33 is a diagram showing one example of the stream identification table.

FIG. 34 is a diagram showing the feedback control table.

FIG. 35 is a diagram showing the feedback control table.

FIG. 36 is a diagram showing the feedback control table.

FIG. 37 is a flowchart showing a flow of processing according to the second embodiment.

FIG. 38 is a diagram showing a configuration example 1 of the communication system.

FIG. 39 is a diagram showing a configuration example 2 of the communication system.

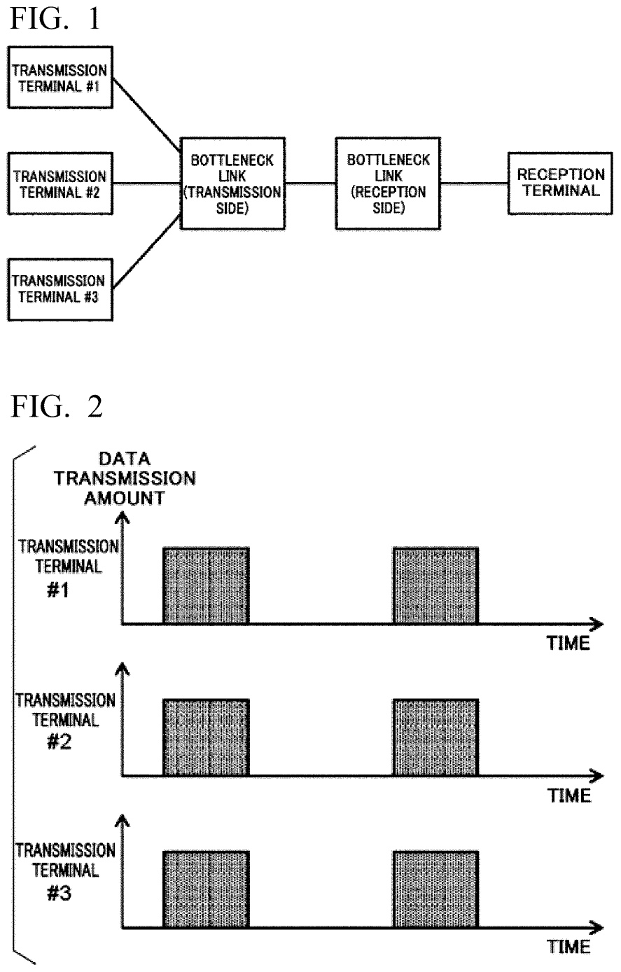

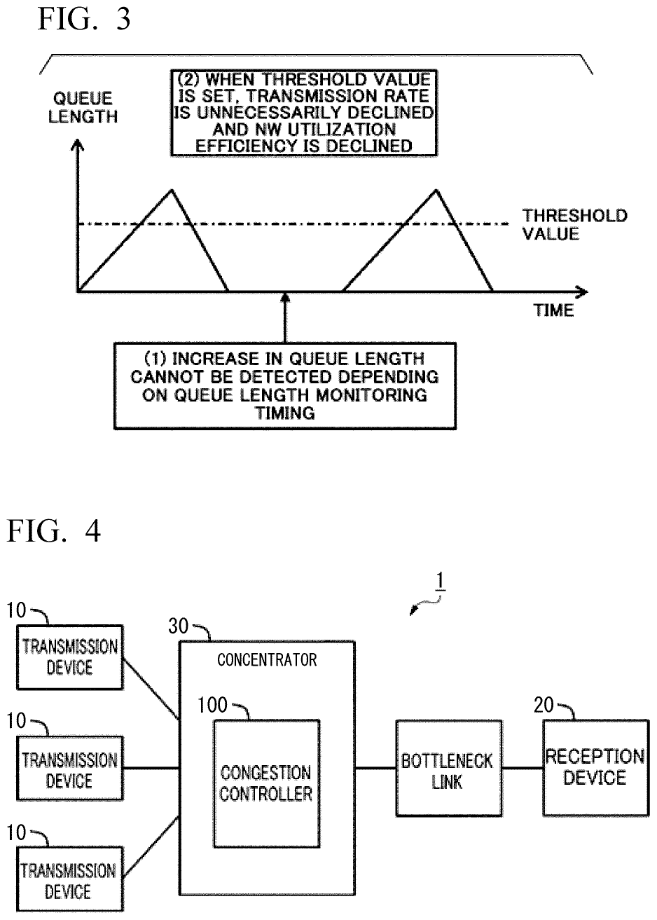

### DESCRIPTION OF EMBODIMENTS

Embodiments of the present invention will be described with reference to the accompanying drawings.

### First Embodiment

### 1. Overview

FIG. 4 is a block diagram schematically showing a configuration example of a communication system 1 according to a present embodiment. The communication system 1 includes a plurality of transmission devices 10 and at least one reception device 20. The plurality of transmission device 10 and the reception device 20 are connected with each other via a communication network. Each transmission device 10 transmits a stream to the reception device 20. The stream is, for example, a video stream. The reception device 20 receives the stream transmitted from the transmission device 10 via the communication network. Note that a bottleneck link exists in the communication network.

The communication system 1 further includes a concentrator 30 installed in the communication network. The concentrator 30 is interposed between the transmission device 10 and the reception device 20. For example, the concentrator 30 is a switch. The concentrator 30 receives a plurality of streams transmitted from each of the plurality of transmission devices. Then, the concentrator 30 transmits each of the received streams to the reception device 20.

The concentrator 30 according to the present embodiment includes a “congestion controller 100” for performing congestion control as necessary. Hereinafter, the overview of congestion control by the congestion controller 100 will be described.

[symbol]

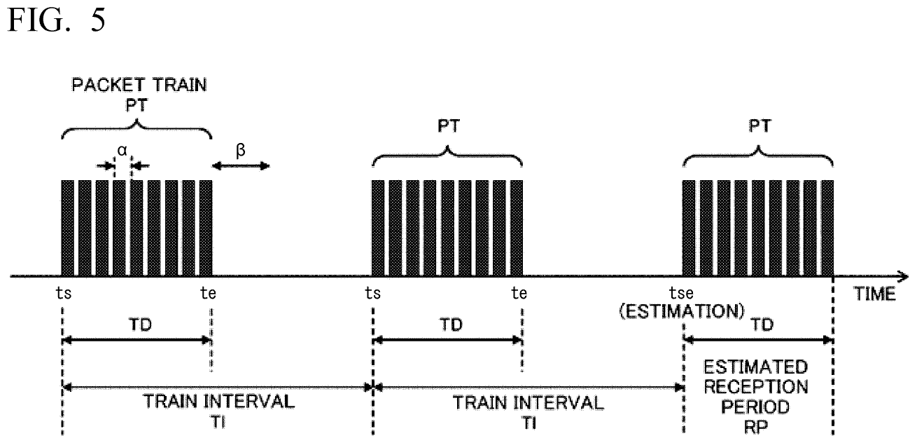

FIG. 5 is a conceptual diagram for explaining one stream ST received by the concentrator 30 from the transmission device 10. The stream ST is constituted by a large number of packets. “Packet interval α” is a time interval between a head of a certain packet and the head of the next packet. A packet group (a series of packets) in which the packet interval α is equal to or less than a fixed time β is referred to as “packet train PT” below. For example, the fixed time β is 100 μs. A train start time point ts and a train end time point te are the start time point and the end time point of one packet train PT, respectively. Train duration TD is duration of one packet train PT, and is a time period from the train start time point ts to the train end time point te. A train interval TI is a time interval between two consecutive packet trains PT. That is, the train interval TI is a difference between the train start time point ts of a certain packet train PT and that of the next packet train PT.

The congestion controller 100 identifies (specifies) the stream ST to which the received packet belongs on the basis of the header information of the received packet. Then, the congestion controller 100 recognizes the packet train PT for each stream ST. In other words, the congestion controller 100 recognizes, for each stream ST, the train start time point ts, the train end time point te, and the train duration TD.

In addition, the congestion controller 100 acquires the train interval TI for each stream ST. For example, the congestion controller 100 calculates the train interval TI on the basis of a recognition result (train start time point ts) of a continuous packet train PT. As another example, the congestion controller 100 may previously acquire information of the train interval TI from media information described based on protocols such as SIP (Session Initiation Protocol) and RTCP (Real-time Transport Control Protocol).

Further, the congestion controller 100 estimates a reception period RP of a future packet train PT for each stream ST. In more detail, the congestion controller 100 estimates the train start time point ts of the next and subsequent packet trains PT on the basis of the recognition result (train start time point ts) of the packet trains PT and the train interval TI. The train start time point ts estimated for the future packet train PT is referred to as “estimated train start time point tse” below. Further, the congestion controller 100 estimates the reception period RP of the future packet train PT based on the estimated train start time point tse and the train duration TD (see FIG. 5).

Furthermore, the congestion controller 100 judges whether or not the respective estimated reception periods RP of the plurality of streams ST overlap. When the estimated reception periods RP of the plurality of streams ST overlap, the congestion controller 100 predicts a congestion occurrence and performs congestion control in order to suppress the congestion. The congestion control according to the present embodiment requests (instructs) the transmission device 10 not to perform “decline in a transmission rate” but to perform “change of transmission timing”.

In more detail, the congestion controller 100 selects at least one “target stream ST_t” from among the plurality of streams ST in which the overlap occurs. The target stream ST_t is a target for shifting the reception period RP. Then, the congestion controller 100 instructs the transmission device 10 transmitting the target stream ST_t to change the transmission timing of the packet train PT. More specifically, the congestion controller 100 transmits (feeds back) feedback information instructing a change in transmission timing to the transmission device 10 transmitting the target stream ST_t.

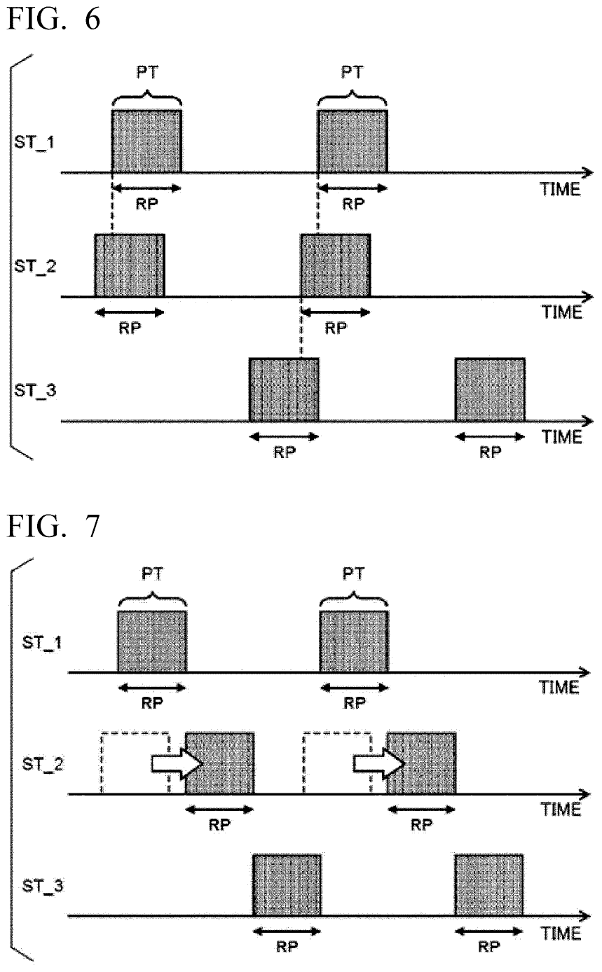

FIG. 6 shows, as one example, the estimated reception period RP for each of three types of streams ST_1, ST_2, and ST_3 received by the concentrator 30. In the example shown in FIG. 6, the estimated reception periods RP of the stream ST_1 and the stream ST_2 overlap, and the estimated reception periods RP of the streams ST_2 and the stream ST_3 overlap. The congestion controller 100 selects, for example, the stream ST_2 as the target stream ST_t. Then, the congestion controller 100 instructs the transmission device 10 transmitting the stream ST_2 to change the transmission timing of the packet train PT.

For example, as shown in FIG. 7, the congestion controller 100 calculates a shift amount of the reception period RP required for eliminating the overlap of the reception period RP with respect to the stream ST_2. Then, the congestion controller 100 instructs the transmission device 10 transmitting the stream ST_2 to delay the transmission timing of the packet train PT by the shift amount. Thus, the congestion occurrence is more surely avoided.

As another example, the congestion controller 100 may simply instruct the change of the transmission timing of the packet train PT without calculating the shift amount. For example, the congestion controller 100 instructs to delay the transmission timing by a fixed time. Thereafter, if the overlap is still not eliminated, the congestion controller 100 instructs (feeds back) again. By repeating the instruction (feedback) , it is expected that the overlap is eliminated and the congestion occurrence is suppressed.

As described above, according to the present embodiment, the concentrator 30 in the communication network includes the congestion controller 100. The congestion controller 100 recognizes the packet train PT for each stream ST to be received, acquires the train interval TI, and estimates the reception period RP of the future packet train PT. When there is an overlap of the estimated reception periods RP of the plurality of streams ST, the congestion controller 100 selects at least one target stream ST_t from among the plurality of streams ST. Then, the congestion controller 100 instructs the transmission device 10 transmitting the target stream ST_t to change the transmission timing of the packet train PT. Thus, the overlap occurrence is suppressed, and the congestion occurrence in the communication network is suppressed. As a result, an increase in queuing delay and packet loss in the bottleneck link are suppressed. These are preferable from the viewpoint of communication quality.

In particular, according to the present embodiment, not “decline in a transmission rate”, but “change of transmission timing” is instructed. Therefore, congestion in the communication network can be suppressed without declining the transmission rate. It is preferable from the viewpoint of network utilization efficiency to suppress the congestion without declining the transmission rate. In addition, since the transmission rate is not reduced, desired data quality of an application is secured. For example, it is not necessary to decline the image quality and resolution of the video stream, and desired video quality can be secured.

Hereinafter, the congestion control according to the present embodiment will be described in more detail.

### 2. Configuration Example

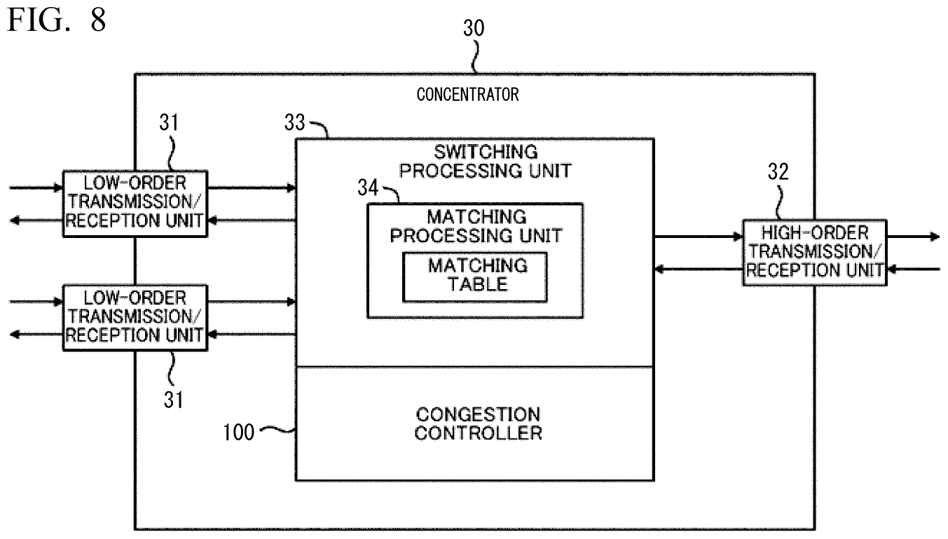

FIG. 8 is a block diagram schematically showing a configuration example of the concentrator 30 according to the present embodiment. The concentrator 30 includes a low-order transmission/reception unit 31, a high-order transmission/reception unit 32, and a switching processing unit 33. The low-order transmission/reception unit 31 is connected to the communication network on the transmission device 10 side. The high-order transmission/reception unit 32 is connected to the communication network on the reception device 20 side.

The switching processing unit 33 performs switching processing for transferring a packet of a main signal. For example, the switching processing unit 33 receives the packet transmitted from the transmission device 10 via the low-order transmission/reception unit 31. Then, the switching processing unit 33 transfers the received packet to the reception device 20 side via the high-order transmission/reception unit 32.

In addition, the switching processing unit 33 includes a matching processing unit 34. The matching processing unit 34 has a matching table in which a stream identifier of a specific stream is registered. As the stream identifier, a combination of a transmission source address, a transmission source port, a destination address, a destination port, and a protocol is exemplified. The matching processing unit 34 collates header information of the received packet with the matching table to identify (specify) the stream ST to which the received packet belongs.

The concentrator 30 further includes the above-described congestion controller 100. The congestion controller 100 performs the congestion control as necessary. The congestion controller 100 may include the matching processing unit 34.

Note that main processing by the congestion controller 100 is performed independently of the transfer of the main signal by the switching processing unit 33. Therefore, the processing by the congestion controller 100 does not affect the transfer of the main signal by the switching processing unit 33.

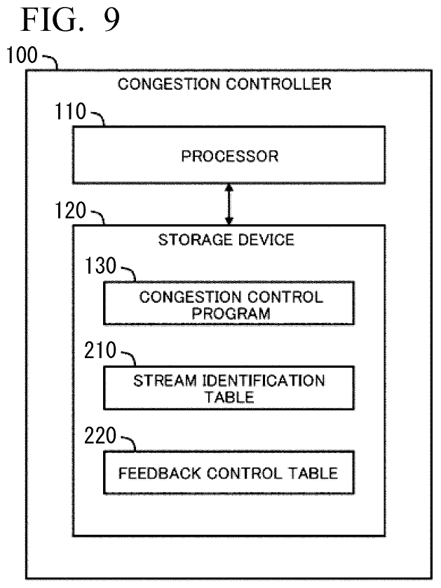

FIG. 9 is a block diagram showing a hardware configuration example of the congestion controller 100. The congestion controller 100 includes one or more processors 110 (hereinafter simply referred to as “processor 110”) and one or more storage devices 120 (hereinafter simply referred to as “storage device 120”).

The processor 110 performs various types of information processing. For example, the processor 110 includes a CPU (Central Processing Unit). The storage device 120 stores various types of information necessary for processing performed by the processor 110. As the storage device 120, a volatile memory, a non-volatile memory, an HDD (Hard Disk Drive), an SSD (Solid State Drive), and the like are exemplified.

The storage device 120 stores a stream identification table 210, a feedback control table 220, and the like. The stream identification table 210 and the feedback control table 220 will be described later.

A congestion control program 130 is a computer program executed by the processor 110. The processor 110 executes the congestion control program 130 to realize a function of the congestion controller 100. The congestion control program 130 is stored in the storage device 120. The congestion control program 130 may be recorded in a computer readable recording medium. The congestion control program 130 may be provided to the congestion controller 100 via the network.

The congestion controller 100 may be realized by using hardware such as an ASIC (Application Specific Integrated Circuit), a PLD (Programmable Logic Device), or an FPGA (Field Programmable Gate Array).

FIG. 10 is a block diagram showing a functional configuration example of the congestion controller 100. The congestion controller 100 includes, as functional blocks, a storage unit 200, a stream information acquisition unit 300, and a feedback control unit 400. The storage unit 200 corresponds to the storage device 120 and stores the stream identification table 210, the feedback control table 220, and the like. The stream information acquisition unit 300 executes stream information acquisition processing. The stream information acquisition unit 300 includes the above-described matching processing unit 34. The feedback control unit 400 executes feedback control processing.

Hereinafter, processing by the stream information acquisition unit 300 and the feedback control unit 400 according to the present embodiment will be described.

### 3. Stream Information Acquisition Processing

The stream information acquisition unit 300 recognizes the packet train PT in which the packet interval α is equal to or less than the fixed time β for each stream ST. Further, the stream information acquisition unit 300 acquires stream information indicating a feature of the stream ST to which the packet train PT belongs on the basis of the recognized information of the packet train PT. Then, the stream information acquisition unit 300 registers acquired stream information in the stream identification table 210.

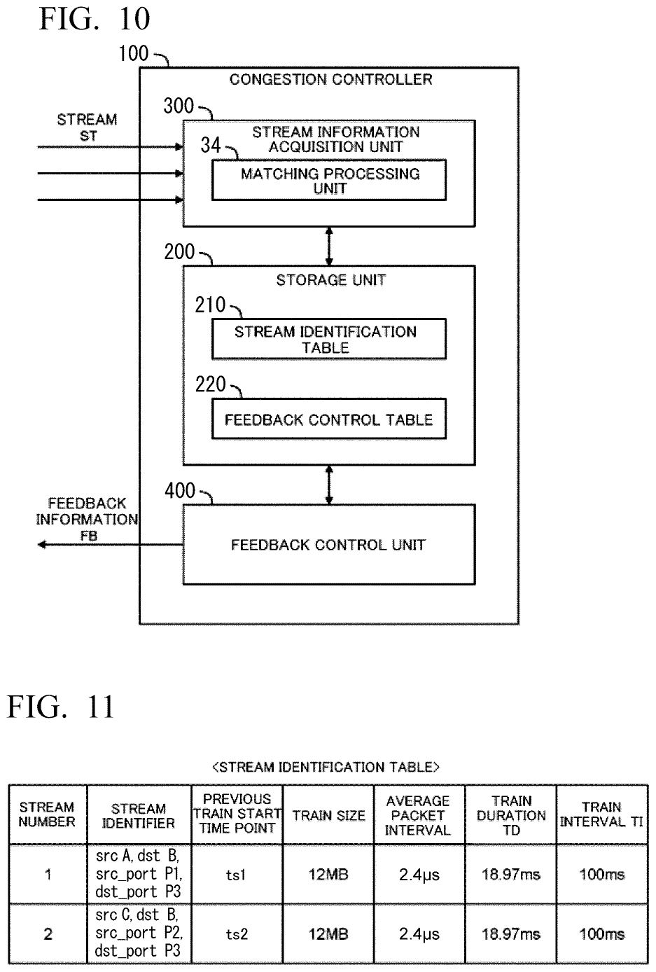

FIG. 11 is a conceptual diagram showing one example of the stream identification table 210. The stream identification table 210 has separate entries for each stream ST. Each entry includes a stream number, a stream identifier, a previous train start time point, a train size, an average packet interval, train duration TD, a train interval TI, and the like. As the stream identifier, the combination of the transmission source address, the transmission source port, the destination address, the destination port, and the protocol is exemplified. The previous train start time point is the train start time point ts of previously recognized the packet train PT. The train size is data amount included in one packet train PT. The average packet interval is an average packet interval α in one packet train PT. The train duration TD is duration of one packet train PT, and is a time period from the train start time point ts to the train end time point te.

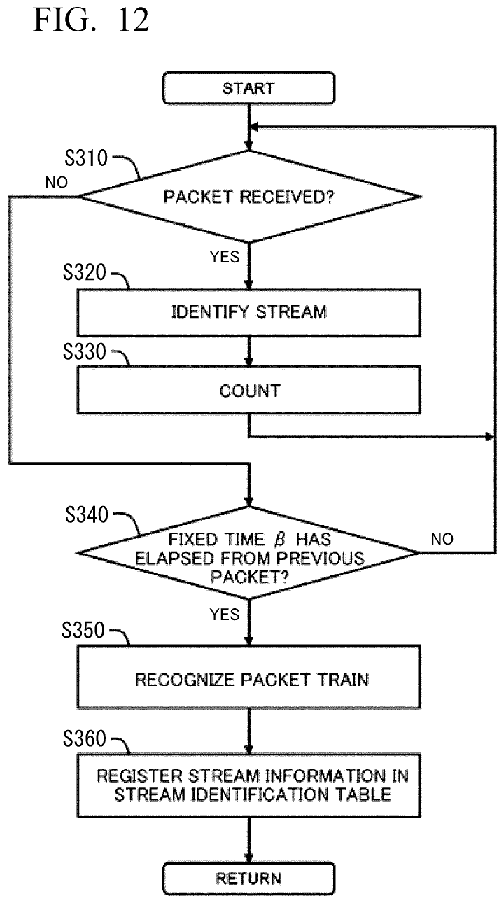

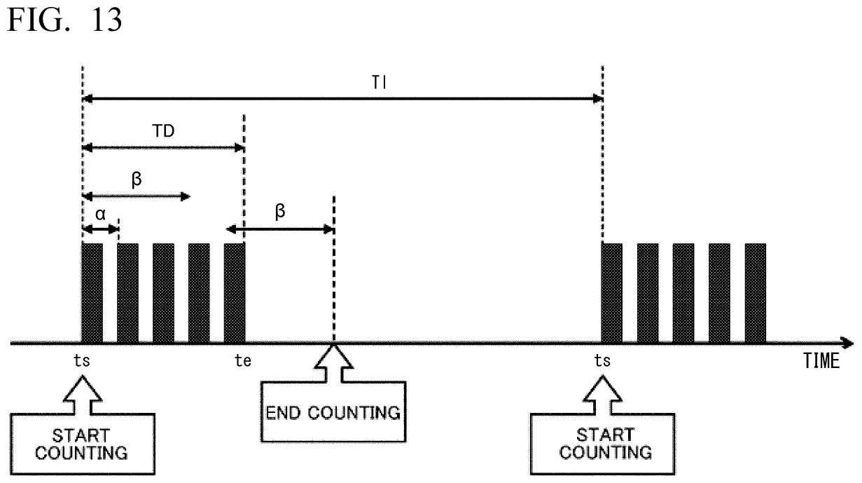

FIG. 12 is a flowchart showing one example of the stream information acquisition processing. FIG. 13 is a conceptual diagram for explaining one example of the stream information acquisition processing.

The matching processing unit 34 of the stream information acquisition unit 300 receives packets of the plurality of streams ST. When the matching processing unit 34 receives the packet (step S310; Yes), the processing proceeds to step S320. During a period when no packets are received (step S310; No), the processing proceeds to step S340.

In step S320, the matching processing unit 34 identifies the stream ST to which the received packet belongs. Specifically, the matching processing unit 34 has the matching table in which the stream identifier of the specific stream is registered. The specific stream is, for example, a stream of particular priority. The priority is defined by, for example, a CoS (Class Of Service) value in the header. The matching processing unit 34 collates the header information of the received packet with the matching table to identify (specify) the stream ST to which the received packet belongs.

The stream information acquisition unit 300 refers to the stream identification table 210 and checks whether or not there is an entry related to the identified stream ST. When the entry related to the identified stream ST is not yet created, the stream information acquisition unit 300 adds a new entry related to the identified stream ST to the stream identification table 210. Further, the stream information acquisition unit 300 writes the stream identifier of the identified stream ST into the new entry (see FIG. 11).

In addition, the matching processing unit 34 has a counter for counting the number of received packets for each stream ST. In step S330, the matching processing unit 34 increments a counter value related to the stream ST identified in step S320. Thereafter, the processing returns to step S310.

In step S340, the matching processing unit 34 judges whether or not the fixed time β (for example, 100 μs) has elapsed from the previous packet reception for each stream ST. When the fixed time β has not elapsed from the previous packet reception (step S340; No), the processing returns to step S310. On the other hand, when the fixed time β has elapsed from the previous packet reception for a certain stream ST (step S340; Yes), the matching processing unit 34 ends counting for the stream ST. Then, the processing related to the stream ST proceeds to step S350.

In step S350, the stream information acquisition unit 300 recognizes the packet train PT. As shown in FIG. 13, a series of packets received from the start of counting to the end of counting correspond to one packet train PT. The train start time point ts and the train end time point te are the start time point and end time point of the recognized packet train PT.

In step S360, the stream information acquisition unit 300 acquires stream information indicating the feature of the stream ST to which the packet train PT belongs on the basis of the recognized information of the packet train PT. Then, the stream information acquisition unit 300 registers the acquired stream information in the stream identification table 210 (see FIG. 11).

The train duration TD is a time period from the train start time point ts to the train end time point te of the packet train PT. In the example shown in FIG. 11, the train duration TD is 18.97 ms.

The train size is the data amount included in the packet train PT. For example, if the packet train PT includes 7906 packets and the size of each packet is 1518 bytes, the train size is 12 MB. The train size may indicate the packet size and the number of received packets instead of the data amount.

The average packet interval is an average packet interval & in the packet train PT. For example, the average packet interval is calculated by “train duration TD/(counter value at the counting end-counter value at the counting start)”. In the example shown in FIG. 11, the average packet interval is 2.4 μs (=18.97 ms/7906).

The train interval TI is a time interval between two consecutive packet trains PT. The train interval TI is calculated from the train start time point ts of the packet train PT previously recognized and the train start time point ts of the packet train PT recognized at this time. In the example shown in FIG. 11, the train interval TI is 100 ms.

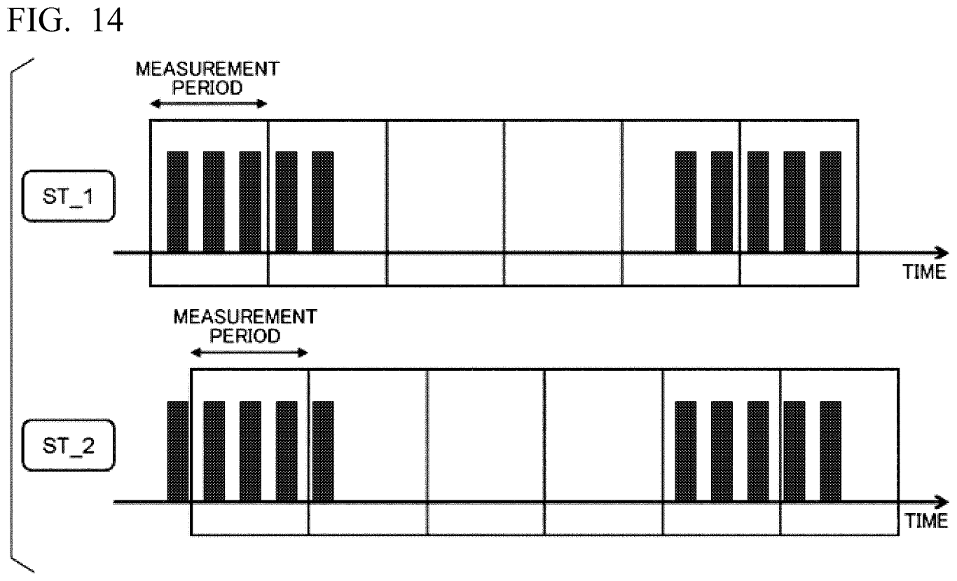

FIG. 14 is a conceptual diagram for explaining a modification example of the stream information acquisition processing. In the modification example, the matching processing unit 34 acquires the total number of received packets and the total number of received bytes within a fixed measurement period as statistical information for each stream ST. The measurement period may be synchronized between the plurality of streams ST or may be deviated due to load distribution. The stream information acquisition unit 300 acquires the stream information on the basis of the statistical information within the fixed measurement period. For example, the train duration TD is a sum of a series of measurement periods in which the total number of received packets continuously exceeds a certain number. The train size is the sum of the total number of received bytes in a series of measurement periods in which the total number of received packets continuously exceeds a certain number. The train interval TI is the sum of a series of measurement periods in which the total number of received packets is continuously equal to or less than a certain number.

The matching processing unit 34 may be different from the stream information acquisition unit 300. In this case, the matching processing unit 34 notifies the stream information acquisition unit 300 of the matching processing result. At this time, the matching processing unit 34 does not necessarily need to notify the matching processing result for all the packets. The matching processing unit 34 may notify the stream information acquisition unit 300 of only a part of the matching processing result in a summarized manner. For example, the matching processing unit 34 may notify the stream information acquisition unit 300 of the counting start timing, the number of received packets (counter value) and the number of received bytes at the counting start, the counting end timing, and the number of received packets (counter value) and the number of received bytes at the counting end. In the case of the modification example shown in FIG. 14, the matching processing unit 34 notifies the stream information acquisition unit 300 of only the statistical information in the fixed measurement period. The stream information acquisition unit 300 acquires the stream information on the basis of the information notified from the matching processing unit 34.

### 4. Feedback Control Processing

FIG. 15 is a flowchart showing processing related to the feedback control processing according to the present embodiment.

In step S410, the feedback control unit 400 estimates the reception period RP of the future packet train PT for each stream ST. Then, the feedback control unit 400 judges whether or not the respective estimated reception periods RP of the plurality of streams ST overlap. When there is overlap (step S410; Yes), the feedback control unit 400 performs the feedback control processing (step S420). In other cases (step S410; No), the processing in the current cycle ends.

Hereinafter, the overlap judgement processing (step S410) and the feedback control processing (step S420) will be described in more detail.

### 4-1. Step S410 (Overlap Judgement Processing)

The feedback control unit 400 estimates the reception period RP of the future packet train PT on the basis of the stream identification table 210. As exemplified in FIG. 11, the stream identification table 210 includes the previous train start time point ts, the train duration TD, and the train interval TI. The feedback control unit 400 estimates the estimated train start time point tse of the future packet train PT on the basis of the previous train start time point ts and the train interval TI. Further, the feedback control unit 400 estimates the reception period RP of the future packet train PT on the basis of the estimated train start time point tse and the train duration TD (see FIG. 5). Furthermore, the feedback control unit 400 judges whether or not the respective estimated reception periods RP of the plurality of streams ST overlap.

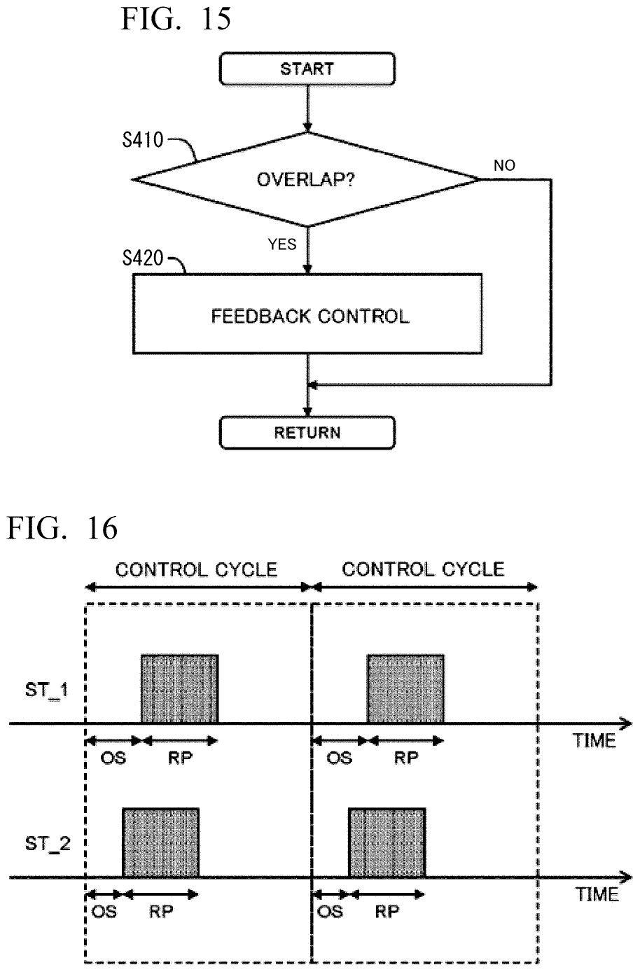

FIG. 16 is a conceptual diagram for explaining one example of the overlap judgement processing. A control cycle is the greatest common divisor of the train interval TI of each of the plurality of streams ST. The feedback control unit 400 calculates an offset OS from the start of the control cycle to the estimated reception period RP (estimated train start time point tse) of the packet train PT for each stream ST. For example, the offset OS related to the stream ST_1 is 15 ms, and the offset OS related to the stream ST_2 is 14 ms. The feedback control unit 400 judges whether or not the respective estimated reception periods RP of the plurality of streams ST overlap on the basis of the offset OS and the estimated reception period RP.

### 4-2. Step S420 (Feedback Control Processing)

### 4-2-1. First Example

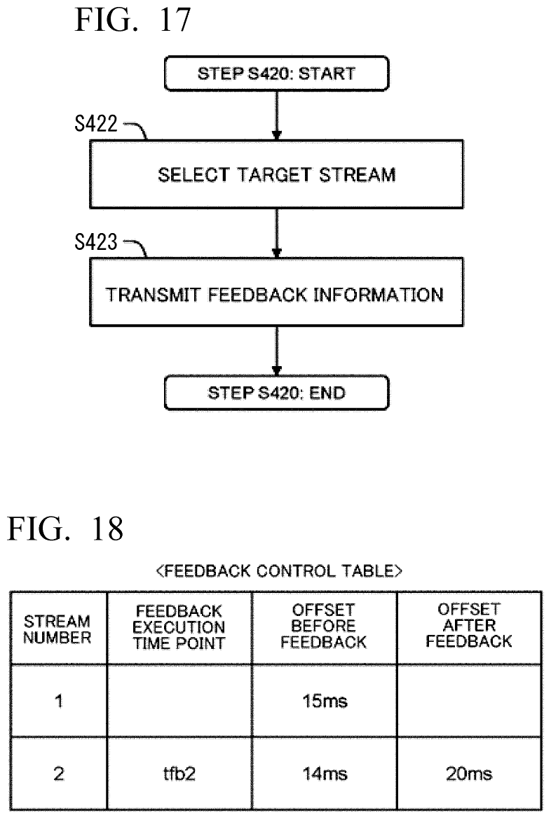

FIG. 17 is a flowchart showing a first example of the feedback control processing (step S420).

In step S422, the feedback control unit 400 selects the target stream ST_t from among the plurality of streams ST in which the overlap occurs. The target stream ST_t is a target for shifting the reception period RP. For example, the feedback control unit 400 selects a stream having a relatively low priority among the plurality of streams ST as the target stream ST_t. That is, when the plurality of streams ST includes a first stream and a second stream having a lower priority than the first stream, the feedback control unit 400 selects the second stream as the target stream ST_t. The feedback control unit 400 may select one stream having the lowest priority as the target stream ST_t. The priority is defined by, for example, the CoS (Class Of Service) value in the header.

In step S423, the feedback control unit 400 transmits (feeds back) feedback information FB to the transmission device 10 transmitting the target stream ST_t. The feedback information FB instructs to change the transmission timing of the packet train PT. For example, the feedback information FB instructs to delay the transmission timing of the packet train PT by the fixed time. Further, the feedback control unit 400 writes an actual result of the feedback control in the feedback control table 220.

FIG. 18 shows one example of the feedback control table 220. The feedback control table 220 has separate entries for each stream ST. Each entry includes a stream number, a feedback execution time point, an offset OS before the feedback, and an offset OS after the feedback. In the example shown in FIG. 18, the target stream ST_t is the stream ST_2. As a result of the feedback control, the offset OS for the stream ST_2 changes from 14 ms to 20 ms.

When the overlap is detected again after the feedback control processing, the feedback control unit 400 transmits the feedback information FB again. By repeating the feedback control processing, the overlap is eliminated and the congestion occurrence is suppressed.

### 4-2-2. Second Example

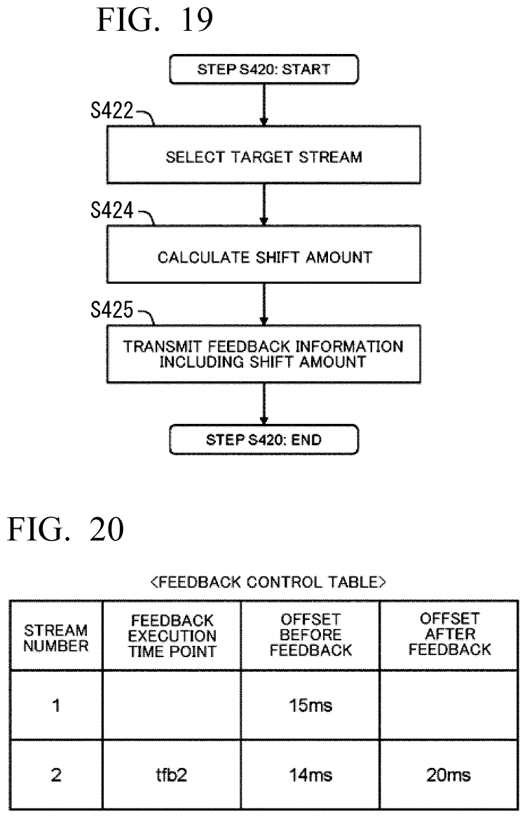

FIG. 19 is a flowchart showing a second example of the feedback control processing (step S420). Step S422 is the same as that of the above-described first example.

In step S424, the feedback control unit 400 calculates the shift amount of the reception period RP required for eliminating the overlap of the reception period RP with respect to the target stream ST_t. At this time, the feedback control unit 400 may determine the shift amount so that the idle time between the shifted reception period RP and the reception period RP of other streams becomes as small as possible.

In step S425, the feedback control unit 400 transmits (feeds back) the feedback information FB to the transmission device 10 transmitting the target stream ST_t. The feedback information FB includes the shift amount calculated in step S424, and instructs to delay the transmission timing of the packet train PT by the shift amount. Further, the feedback control unit 400 writes the actual result of the feedback control in the feedback control table 220.

FIG. 20 shows one example of the feedback control table 220. Explanations that are redundant with those in FIG. 18 are appropriately omitted. In the example shown in FIG. 20, each entry further includes “shift amount”. The offsets OS before feedback related to the streams ST_1 and ST_2 are 15 ms and 14 ms, respectively. When the train duration TD is 18.97 ms (see FIG. 11), the transmission timing of the packet train PT of the stream ST_2 is delayed by 20 ms, for example, so that the overlap is eliminated. Therefore, the shift amount is calculated as 20 ms. As a result of the feedback control, the offset OS related to the stream ST_2 changes from 14 ms to 34 ms.

According to the second example, the shift amount is calculated, and the shift amount is explicitly notified, so that the congestion occurrence can be more reliably avoided.

### 4-2-3. Third Example

In the third example of the feedback control processing, “total reception rate” of the plurality of streams ST in the period in which the overlap occurs is taken into consideration. When the total reception rate exceeds a link rate of an output port (high-order transmission/reception unit 32) of the concentrator 30, the feedback control unit 400 selects the target stream ST_t and transmits the feedback information FB.

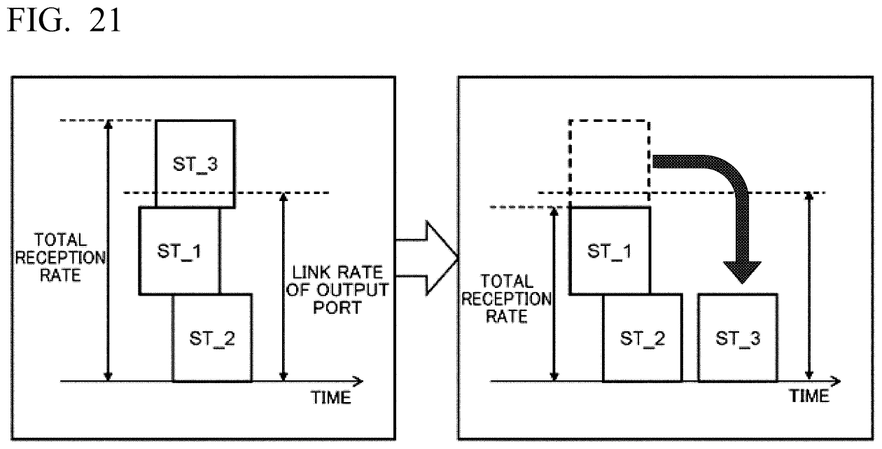

As one example, three types of streams ST_1, ST_2, and ST_3 shown in FIG. 21 are considered. There is the overlap of estimated reception periods RP of the streams ST_1, ST_2, and ST_3.

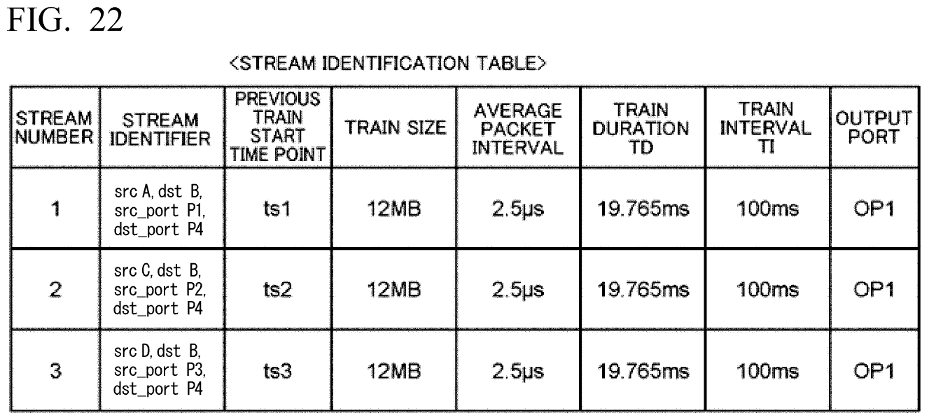

FIG. 22 shows an example of a stream identification table 210. In the example shown in FIG. 22, the stream identification table 210 further shows an output port from which the packet of each stream ST is outputted. The output ports related to the streams ST_1, ST_2, and ST_3 are the same OP1.

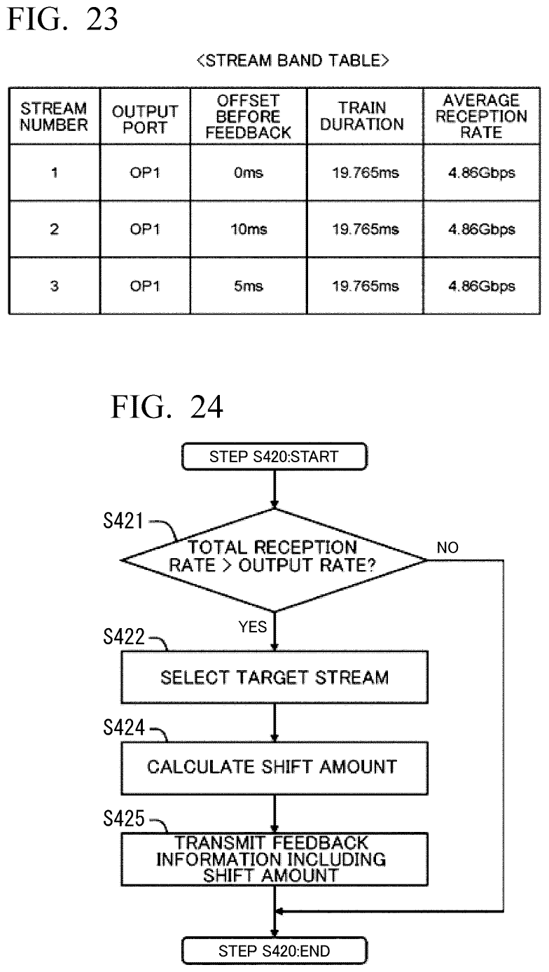

FIG. 23 shows one example of a stream band table 230. The stream band table 230 has different entries for each stream ST. Each entry includes a stream number, an output port, an offset OS before the feedback, a train duration TD, and an average reception rate. Such a stream band table 230 is stored in the storage device 120. The stream band table 230 may be included in the feedback control table 220.

The average reception rate of each stream ST is 4.86 Gbps. It is assumed that the link rate of the output port OP1 is 10 Gbps. In this case, the total reception rate of ST_1, ST_2, and ST_3 in the period in which the overlap occurs exceeds the link rate of the output port OP1. Therefore, the feedback control unit 400 selects the target stream ST_t and executes the feedback control. In the example shown in FIG. 21, the stream ST_3 is selected as the target stream ST_t. The feedback control unit 400 transmits (feeds back) the feedback information FB to the transmission device 10 transmitting the stream ST_3.

FIG. 24 is a flowchart showing the third example of the feedback control processing (step S420) in a summarized manner.

In step S421, the feedback control unit 400 judges whether or not the total reception rate of the plurality of streams ST in the period in which the overlap occurs exceeds the link rate of the output port. When the total reception rate exceeds the link rate of the output port (step S421; Yes), the processing proceeds to step S422. On the other hand, when the total reception rate does not exceed the link rate of the output port (step S421; No), the step S420 ends.

In step S422, the feedback control unit 400 selects the target stream ST_t from among the plurality of streams ST in which the overlap occurs. For example, the feedback control unit 400 selects at least one target stream ST_t so that the total reception rate is equal to or less than the link rate of the output port on the basis of the stream band table 230. That is, the feedback control unit 400 selects at least one target stream ST_t so as to eliminate excess of the total reception rate.

Thereafter, the feedback control unit 400 executes step S424 and step S425 similarly to the case of the second example. Alternatively, the feedback control unit 400 may execute step S423 similarly to the case of the first example.

As described above, according to the third example, the feedback control is executed when the total reception rate of the plurality of streams ST in the period in which the overlap occurs exceeds the link rate of the output port. Therefore, the feedback control is prevented from being executed more than necessary. Thus, the network utilization efficiency is prevented from being unnecessarily declines.

### 5. Application Example

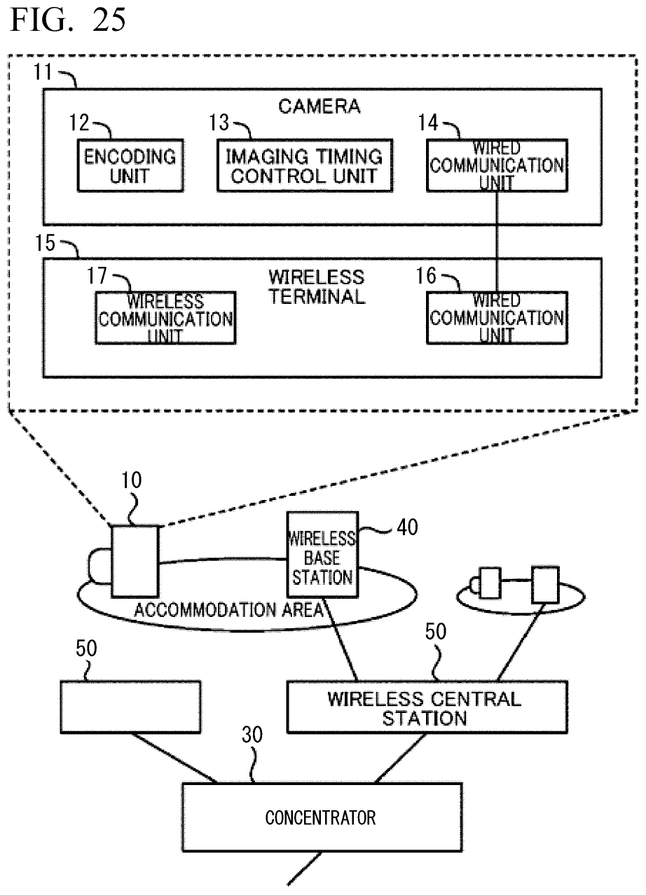

FIG. 25 is a conceptual diagram for explaining an application example of the concentrator 30 according to the present embodiment.

The transmission device 10 includes a camera 11. The camera 11 performs imaging processing and regularly transmits image data of low compression rate or non-compressed image data. The camera 11 includes an encoding unit 12, an imaging timing control unit 13, and a wired communication unit 14. The imaging timing control unit 13 can variably set imaging timing. For example, the camera 11 outputs ten images in one second from the wired communication unit 14. The image size per sheet is 12 MB (4,000 pixels×3,000 pixels×8 bits color).

The camera 11 is connected to a wireless terminal 15. The wireless terminal 15 transmits the image data outputted from the camera 11 to the wireless base station 40. The wireless terminal 15 includes a wired communication unit 16 and a wireless communication unit 17. For example, the wired communication unit 14 of the camera 11 and the wired communication unit 16 of the wireless terminal 15 are connected by 5GBase-T. The wireless communication unit 17 performs wireless communication with the wireless base station 40. For example, the communication at a wireless peak rate of 5 Gbps is possible. Note that it is assumed that interference between the accommodation areas can be ignored by utilizing beam forming or by geographically dividing the areas.

The wireless base station 40 and the wireless central station 50 are connected by an optical communication network of 10 Gbps. The wireless central station 50 and the concentrator 30 are also connected by the optical communication network of 10 Gbps.

In the communication network described above, the image data is periodically transmitted from the plurality of cameras 11. Therefore, there is a possibility that temporary congestion occurs periodically. The concentrator 30 performs the congestion control as necessary and transmits the feedback information FB to the camera 11. The imaging timing control unit 13 of the camera 11 receiving the feedback information FB changes the imaging timing in accordance with the feedback information FB. This is equivalent to changing the transmission timing of the image data. As a result, the congestion occurrence of the communication network is suppressed.

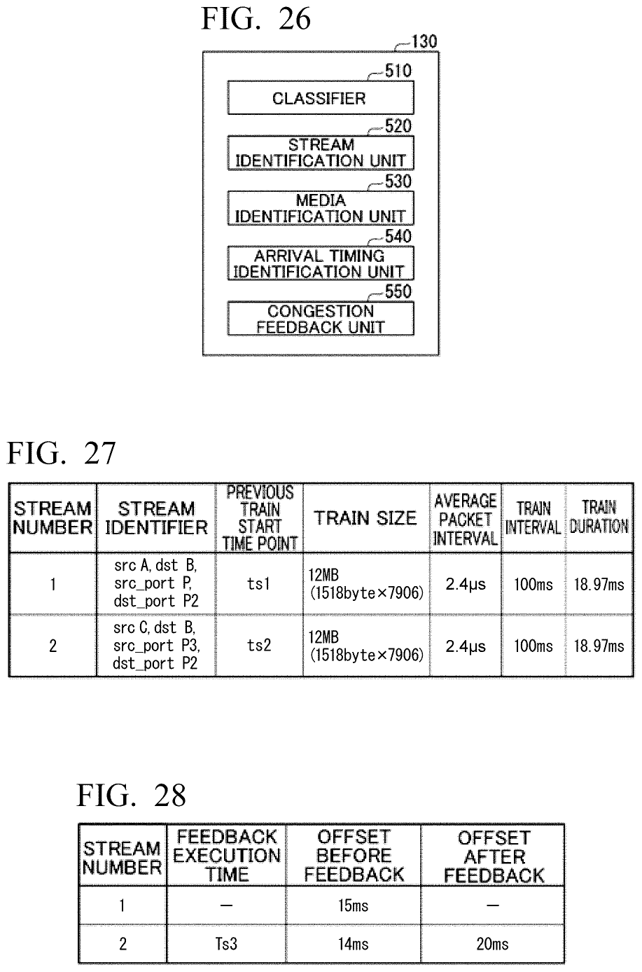

FIG. 26 is a diagram showing a configuration example of the congestion control program 130 in the application example of the concentrator 30 shown in FIG. 25. The congestion control program 130 shows the configuration of the congestion control program in the configuration shown in FIG. 9. Note that, in the configuration shown in FIG. 26, instead of the stream information acquisition unit 300 shown in FIG. 10, a classifier 510, a stream identification unit 520, and a media identification unit 530 is provided to have the same function as that of the stream information acquisition unit 300.

The congestion control program 130 is constituted of a classifier 510, a stream identification unit 520, a media identification unit 530, an arrival timing identification unit 540, and a congestion feedback unit 550.

In the configuration example shown in FIG. 26, an example will be described, in which connection negotiation by SIP (Session Initiation Protocol)/SDP (Session Description Protocol) is performed between the camera 11 and the host device before the arrival of video data.

When the concentrator 30 receives the video data of high priority, the classifier 510 identifies the priority and sends header information including a frame size and an arrival time point to the stream identification unit 520. The stream identification unit 520 identifies the stream from the camera 1 and the stream from the camera 2 from a transmission source IP address, a transmission source L4 port number, a transmission destination IP address, a transmission destination L4 port number, and a protocol number of the video data transmitted from each camera 11. The stream identification unit 520 registers the identified contents in the stream identification table 210.

The media identification unit 530 counts the number of continuous packets whose time between the head of the packet and the head of the packet is 100 μs or less from the header information of the identified stream, and registers that the number of packets is 7906 packets (each 1518 bytes) per packet train in the stream identification table 210.

In addition, the media identification unit 530 registers that the interval between packet trains is 100 ms from a difference between a packet similarly arriving at first over 100 μs and a reception time point described as a head of the previous packet train from the header information of the identified stream in the stream identification table 210.

FIG. 27 is a diagram showing one example of the stream identification table 210 in which various types of information are registered. FIG. 27 shows the stream identification table in the case where two streams are received as one example. The stream of the stream 1 has a transmission source A and a transmission destination B. The reception port is P, and the transmission port is P2. The stream of the stream 2 has a transmission source C and a transmission destination of B. The reception port is P3, and the transmission port is P2. The train size of both the stream 1 and the stream 2 is 12 MB. The average packet interval of both the stream 1 and the stream 2 is 2.4 μs. The train interval of both the stream 1 and the stream 2 is 100 ms. The train duration of both the stream 1 and the stream 2 is 18.97 seconds.

The arrival timing identification unit 540 refers to the stream identification table 210 and calculates an arrival offset time point of each stream with a control cycle which is the greatest common divisor of the train interval of each stream as a reference. As one example, it is assumed that the arrival offset time point of the stream 1 is 15 ms from the head of the control cycle and the arrival offset time point of the stream 2 is 14 ms.

In this case, when the arrival timing identification unit 540 refers to the stream identification table 210, the arrival timing identification unit 540 detects that the train arrival end of the stream 2 overlaps with the train start time point of the stream 1.

When the arrival timing identification unit 540 detects the overlap, the congestion feedback unit 550 transmits the feedback information (reset command) to an IP address of the camera 11 that is a transmission source of the stream 2, and registers the feedback transmission time point Ts3 in the feedback control table 220.

FIG. 28 is a diagram showing one example of the feedback control table 220 in which various types of information are registered. As described above, since the arrival offset time point of the stream 1 is 15 ms from the head of the control cycle, the offset before the feedback is 15 ms. Similarly, since the arrival offset time point of the stream 2 is 14 ms, the offset before the feedback is 12 ms. By the feedback transmitted to the camera 11 of the stream 2, it is shown that the offset of the stream 2 after the feedback is 20 ms.

After the feedback transmission, if the overlap of the stream 1 and the stream 2 is eliminated by the arrival timing identification unit 540, the congestion feedback unit 550 does not perform the control. On the other hand, when the overlap is detected again after the feedback transmission, the congestion feedback unit 550 calculates a transmission time point so as not to overlap with the offset time point of other streams on the basis of the feedback control table, and transmits the feedback again. By doing this, the congestion due to the overlap of the plurality of streams can be avoided.

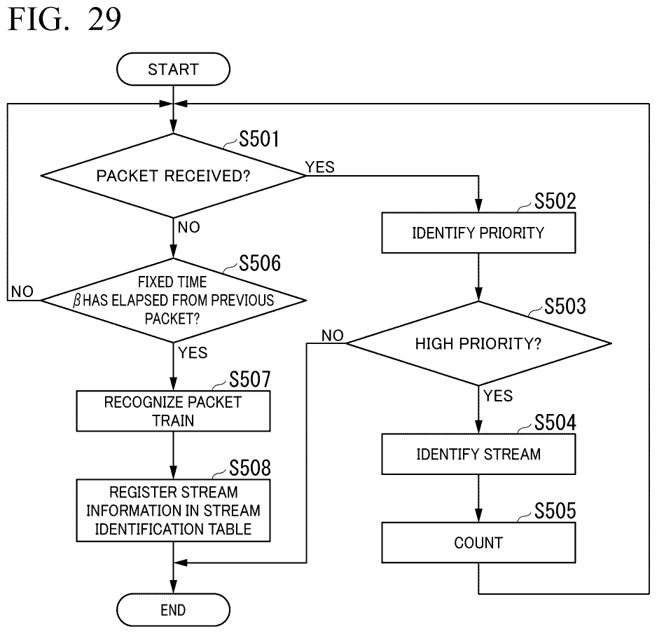

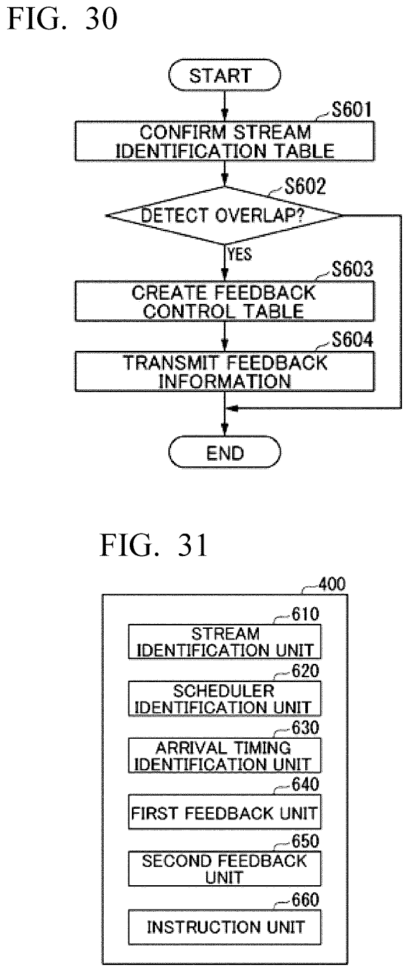

FIG. 29 and FIG. 30 are flowcharts showing a flow of processing of the congestion control program 130 shown in FIG. 26. When the concentrator 30 receives the packet (step S501; Yes), the classifier 510 identifies the priority (step S502). The classifier 510 judges whether or not the priority is a predetermined high priority (step S503). When the priority is not the high priority (step S503; No), the processing ends. On the other hand, when the priority is the high priority (step S503; Yes), the classifier 510 identifies the stream to which the received packet belongs (step S504).

The stream identification unit 520 refers to the stream identification table 210, counts (increments) the number of received packets when an entry related to the identified stream ST exists (step S504), and returns to step S501. On the other hand, when there is no entry related to the identified stream, an entry is created, the number of received packets corresponding to the entry is counted (step S505), and the processing returns to step S501.

When the concentrator 30 does not receive the packet (step S501; No), the stream identification unit 520 judges whether or not the fixed time β (for example, 100 μs) has elapsed from the previous packet reception for each stream (step S506). When the fixed time β has not elapsed from the previous packet reception (step S506; No), the processing returns to step S501. On the other hand, when the fixed time β has elapsed from the previous packet reception for a certain stream (step S506; Yes), the stream identification unit 520 ends the counting for the streams. Thus, the stream identification unit 520 recognizes the packet train PT (step S507).

The stream identification unit 520 acquires the stream information indicating the feature of the stream ST to which the packet train belongs on the basis of the recognized information of the packet train. Then, the stream identification unit 520 registers the acquired stream information in the stream identification table 210 (step S508), and ends the processing.

In FIG. 30, the arrival timing identification unit 540 confirms the stream identification table 210 (step S601), and judges whether or not the overlap is detected (step S602). When the arrival timing identification unit 540 does not detect the overlap (step S602; No), the processing ends. On the other hand, when the overlap is detected (step S602; Yes), the congestion feedback unit 550 creates the feedback control table 220 (step S603), transmits the feedback information to the IP address of the camera 11 which is the transmission source (step S604), and ends the processing.

### Second Embodiment

Next, an example in which the stream is grouped for each base station to which the streams are transmitted and the imaging timing of the camera 11 is explicitly specified from the concentrator will be described. Note that, in the following description, “group” is expressed as “scheduler”. In addition, in order to simplify the description, the description is performed on the assumption that the photographing timing and the transmission timing are the same timing. FIG. 31 is a diagram showing a configuration example of the feedback control unit 400 according to a second embodiment. The feedback control unit 400 is constituted of a stream identification unit 610, a scheduler identification unit 620, an arrival timing identification unit 630, a first feedback unit 640, a second feedback unit 650, and an instruction unit 660.

The stream identification unit 610 identifies the stream identifier, the previous train start time point, the train size, the average packet interval, the train duration, and the train interval. The scheduler identification unit 620 identifies the scheduler of the stream. The arrival timing identification unit 630 identifies the arrival timing of the packet train. The first feedback unit 640 derives the transmission start timing in which reception periods of packet trains included in streams belonging to the same scheduler do not overlap in the group. The first feedback unit 640 is one example of a first derivation unit. The second feedback unit 650 derives the transmission start timing in which reception periods of packet trains transmitted at the transmission start timing derived by the first feedback unit 640 does not overlap between different schedulers. The second feedback unit 650 is one example of a second derivation unit. The instruction unit 660 instructs the camera 11 (transmission terminal) on the transmission start timing derived by the second feedback unit 650.

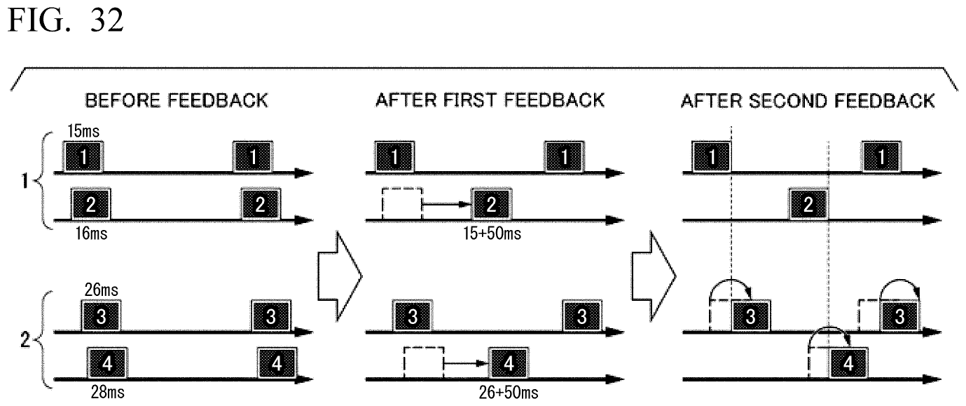

FIG. 32 is a diagram showing a derivation example of the first feedback unit 640 and the second feedback unit 650. In FIG. 32, the train described as “1” is a train of stream 1. The train described as “2” is a train of stream 2. The train described as “3” is a train of stream 3. The train described as “4” is a train of stream 4.

The stream 1 and the stream 2 belong to the same scheduler (referred to as “scheduler 1”). The stream 3 and the stream 4 belong to the same scheduler (referred to as “scheduler 2”). In addition, “before feedback” described in FIG. 32 shows a packet train before the derivation by the first feedback unit 640 (naturally, before the derivation by the second feedback unit 650). “After first feedback” shows a packet train when transmitted at the timing derived by the first feedback unit 640. “After second feedback” shows a packet train when transmitted at the timing derived by the second feedback unit 650.

The previous train start time point ts1 in the stream 1 is 15 ms. The previous train start time point ts2 in the stream 2 is 16 ms. The previous train start time point ts3 in the stream 3 is 26 ms. The previous train start time point ts4 in the stream 4 is 28 ms.

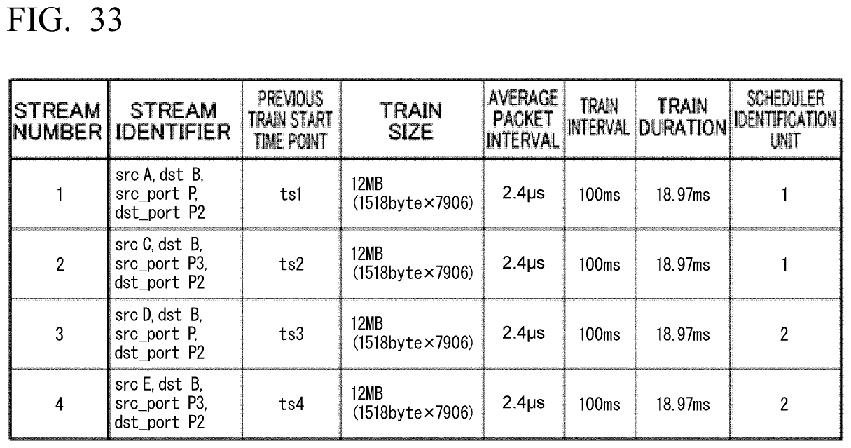

FIG. 33 is a diagram showing one example of the stream identification table 210. FIG. 33 shows the stream identification table when four streams shown in FIG. 32 are received. The stream of the stream 1 has a transmission source A and a transmission destination B. The reception port is P, and the transmission port is P2. The stream of the stream 2 has a transmission source C and a transmission destination of B. The reception port is P3, and the transmission port is P2. The train size of both the stream 1and the stream 2 is 12 MB. The average packet interval of both the stream 1 and the stream 2 is 2.4 μs. The train interval of both the stream 1 and the stream 2 is 100 ms. The train duration of both the stream 1 and the stream 2 is 18.97 seconds. The scheduler identifier shows a scheduler to which the scheduler identifier belongs. The stream 1 and the stream 2 belong to the same scheduler, and both scheduler identifiers are 1.

The stream of the stream 3 has a transmission source of D and a transmission destination of B. The reception port is P, and the transmission port is P2. The stream of the stream 4 has a transmission source is E and a transmission destination is B. The reception port is P3, and the transmission port is P2.The train size of both the stream 3 and the stream 4 is 12 MB. The average packet interval of both the stream 3 and the stream 4 is 2.4 μs. The train interval of both the stream 3 and the stream 4 is 100 ms. The train duration of both the stream 3 and the stream 4 is 18.97 seconds. The stream 3 and the stream 4 belong to the same scheduler, and both scheduler identifiers are 2.

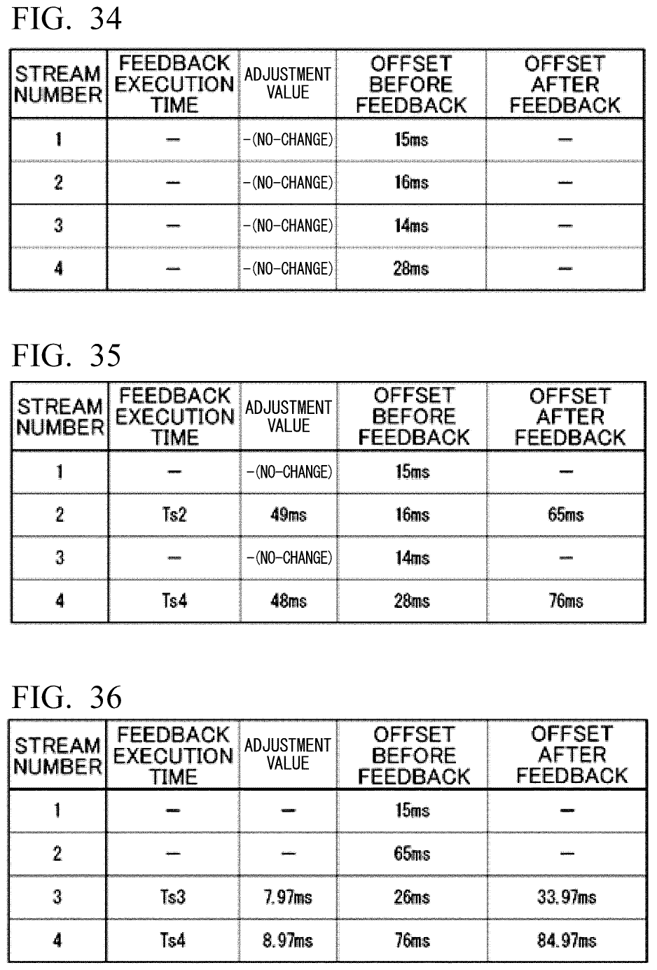

FIG. 34, FIG. 35, and FIG. 36 show the feedback control table 220. In the feedback control table 220 shown in FIG. 34, FIG. 35, and FIG. 36, an item “adjustment value” is newly provided. The adjustment value shows a value adjusted by the first feedback unit 640 and the second feedback unit 650. The feedback control table 220 shown in FIG. 34 is the feedback control table 220 in “before feedback” in FIG. 32. The feedback control table 220 shown in FIG. 35 is the feedback control table 220 in “after first feedback” in FIG. 33. The feedback control table 220 shown in FIG. 36 is the feedback control table 220 in “after second feedback” in FIG. 34.

Based on this, description will be provided with reference to FIG. 32 again. The first feedback unit 640 derives the transmission start timing in which the reception periods of the packet trains included in the streams belonging to the scheduler 1 does not overlap in the scheduler. At this time, the stream 2 and the stream 4 having the large numerical value of the offset time point are derived, respectively.

The derivation method in the scheduler 1 is derived by calculating ts1+(train interval/the number of streams belonging to the same scheduler). When ts1=15 ms is satisfied, the train interval is 100 ms, and the number of streams belonging to the same scheduler is 2, the transmission timing of the packet train 2 is set to 15 ms+100/2 ms=15 ms+50 ms=65 ms.

Similarly, the first feedback unit 640 derives the transmission start timing in which the reception periods of the packet trains included in the streams belonging to the scheduler 2 does not overlap in the scheduler. The derivation method is derived by calculating ts3+(train interval/the number of streams belonging to the same scheduler). When ts3=26 ms is satisfied, the train interval is 100 ms, and the number of streams belonging to the same scheduler is 2, the transmission timing of the packet train 4 is set to 26 ms+100/2 ms=26 ms+50 ms=76 ms.

Thus, as shown in FIG. 35, the offset after the feedback of the stream 2 becomes 65 ms and the adjustment value becomes 49 ms. In addition, the offset after the feedback of the stream 4 becomes 76 ms, and the adjustment value becomes 48 ms. By doing this, the congestion in the same scheduler can be suppressed.

Next, the second feedback unit 650 derives the transmission start timing in which the reception periods of the packet trains transmitted at the transmission start timing derived by the first feedback unit 640 do not overlap in the different groups.

As shown in FIG. 32, after the first feedback, the packet train 3 overlaps the packet train 1 and the packet train 4 overlaps the packet train 2. Then, the second feedback unit 650 derives the transmission start timing so that the packet train 3 and the packet train 4 do not overlap.

This will be described more specifically. The offset of the stream 1 is 15 ms. The offset of the stream 2 is 65 ms. The offset of the stream 3 is 26 ms. The offset of the stream 4 is 76 ms. Then, the duration of the packet train is 18.97 ms.

Then, the second feedback unit 650 sets the offset of the stream 3 to be 33.97 ms or later which is the sum of the offset of the packet train of the stream 1 15 ms and the duration of the packet train 18.97 ms, so that the packet train of the stream 3 does not overlap the packet train of the stream 1. Here, the offset after the feedback is set to 33.97 ms, and the adjustment value in this case becomes 7.97 ms.

Similarly, the second feedback unit 650 sets the offset of the stream 4 to be 84.97 ms or later which is the sum of the offset of the packet train of the stream 2 65 ms and the duration of the packet train 18.97 ms, so that the packet train of the stream 4 does not overlap the packet train of the stream 2. Here, the offset after the feedback is set to 84.97 ms, and the adjustment value in this case becomes 8.97 ms.

As described above, the instruction unit 660 instructs the transmission timing in which the photographing timing is delayed by 49 ms to the camera 11 corresponding to the stream 2. The instruction unit 660 instructs the transmission timing in which the photographing timing is delayed by 7.97 ms to the camera 11 corresponding to the stream 3. The instruction unit 660 instructs the transmission timing in which the photographing timing is delayed by 56.97 (=48+8.97) ms to the camera 11 corresponding to the stream 4. By doing this, the overall congestion can be suppressed.

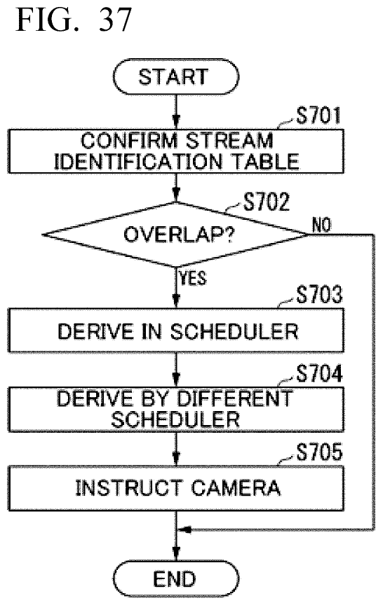

FIG. 37 is a flowchart showing a flow of the processing according to the second embodiment. In FIG. 37, the first feedback unit 640 confirms the stream identification table 210 (step S701), and judges whether or not there is the overlap (step S702). When there is no overlap (step S702; No), the processing is ended.

When there is the overlap (step S702; Yes), the first feedback unit 640 derives the transmission start timing which does not overlap in the scheduler as described above (step S703). Next, the second feedback unit 650 derives the transmission start timing which does not overlap between different schedulers as described above (step S704). The instruction unit 660 instructs the derived transmission start timing to the camera 11 (step S705), and ends the processing. The camera 11 starts the transmission at the transmission start timing instructed by the instruction unit 660.

Thus, the imaging timing of the camera 11 is explicitly specified so that the congestion in the concentrator 30 does not occur, so that instantaneous congestion does not occur in the concentrator 30. Further, delay caused by buffering before the arrival from the camera 11 to the concentrator 30 can be avoided.

Furthermore, since each packet train does not overlap by deriving the transmission start timing in which the reception periods do not overlap and all bands are assigned to one packet train, the congestion in the communication network can be suppressed while reducing the decline in in the transmission rate.

Although the embodiment described above has been described with reference to the embodiment in which the congestion controller (congestion control device) is provided inside the concentrator 30 as shown in FIG. 4 and FIG. 31, the function of the congestion controller may be provided outside the concentrator. Configuration example 1 and configuration example 2 of two communication systems in which the function of the congestion controller is provided outside the concentrator will be described.

### Configuration Example 1 of Communication System

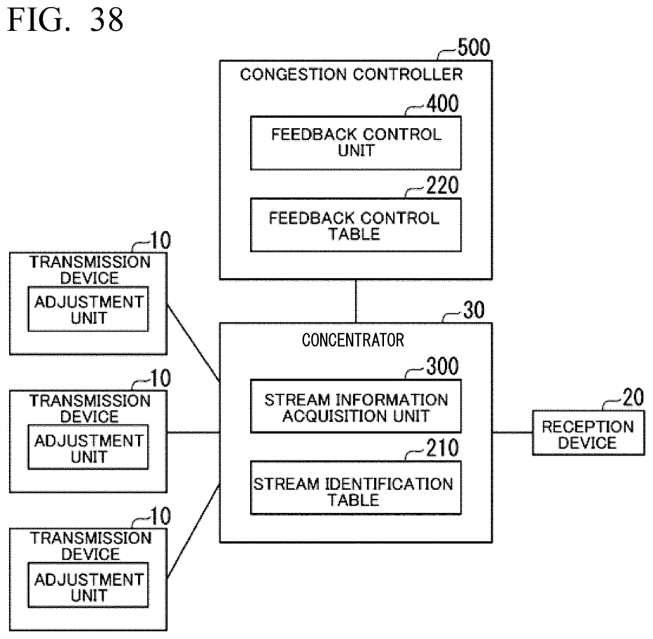

FIG. 38 is a diagram showing a configuration example 1 of each device in the case where the function of the congestion controller is provided outside the concentrator. The concentrator 30 includes the above-described stream information acquisition unit 300 and the stream identification table 210. That is, the concentrator 30 has only the function of identifying the stream. Then, the congestion controller 500 provided outside the concentrator 30 includes the above-described feedback control unit 400 and the feedback control table 220.

As shown in FIG. 38, the concentrator 30 identifies the stream and is configured so that the congestion controller 500 can refer to the stream identification table 210. In addition, the congestion controller 500 transmits the feedback information to the transmission device 10 via the concentrator 30. When the transmission device 10 receives the feedback information, the adjustment unit adjusts the transmission timing in accordance with the feedback information. By configuring like this, the same control as that of FIG. 4 can be performed.

### Configuration Example 2 of Communication System

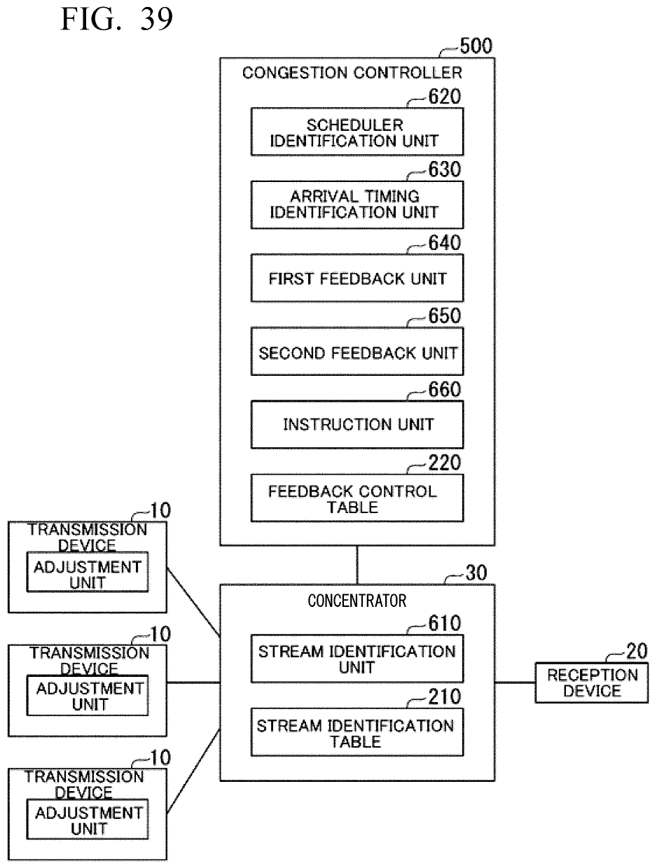

FIG. 39 is a diagram showing a configuration example 2 of each device in the case where the function of the congestion controller is provided outside the concentrator. The configuration example 2 shows a configuration example using the functions shown in FIG. 31. The concentrator 30 includes the above-described stream information identification unit 610 and the stream identification table 210. That is, the concentrator 30 has only a function of identifying the stream. Then, the congestion controller 500 provided outside the concentrator 30 includes the above-described scheduler identification unit 620, the arrival timing identification unit 630, the first feedback unit 640, the second feedback unit 650, the instruction unit 660, and the feedback control table 220.

As shown in FIG. 39, the concentrator 30 identifies the stream and is configured so that the congestion controller 500 can refer to the stream identification table 210. In addition, the first feedback unit 640 in the congestion controller 500 derives the transmission start timing in which the reception periods of the packet trains included in the streams belonging to the same scheduler do not overlap in the group. The second feedback unit 650 derives the transmission start timing in which the reception periods of the packet trains transmitted at the transmission start timing derived by the first feedback unit 640 does not overlap between different schedulers. The instruction unit 660 instructs the transmission terminal 10 on the transmission start timing derived by the second feedback unit 650 via the concentrator 30. When the transmission device 10 receives the feedback information, the adjustment unit adjusts the transmission timing in accordance with the feedback information. By configuring like this, the same control as that of FIG. 31 can be performed.

In the above-described configuration example 1 and the configuration example 2, the concentrator identifies the stream, but the congestion controller 500 may also identify the stream. In this case, the congestion controller receives the stream transmitted by the transmission device from the concentrator as it is and identifies the stream. In addition, the congestion controller discards data other than the data necessary for the feedback among the data in the stream. In this case, it is only necessary to provide the concentrator 30 with the function of transmitting the stream to the congestion controller and the function of transmitting the feedback information from the congestion controller to the transmission device.

The first feedback unit 640, the second feedback unit 650, and the instruction unit 660 are configured by using a processor such as a CPU (Central Processing Unit) and a memory. In this case, when the processor executes a program, the first feedback unit 640, the second feedback unit 650, and the instruction unit 660 function as a first feedback unit 640, a second feedback unit 650, and an instruction unit 660. Note that all or some of the functions of the first feedback unit 640, the second feedback unit 650, and the instruction unit 660 may be realized by using hardware such as an ASIC (Application Specific Integrated Circuit), a PLD (Programmable Logic Device), or an FPGA (Field Programmable Gate Array). The above-mentioned program may be recorded in a computer-readable recording medium. The computer-readable recording medium is a portable medium such as a flexible disk, a magneto-optical disk, a ROM, a CD-ROM, or a semiconductor storage device (for example SSD: Solid State Drive), for example, or a storage device such as a hard disk and a semiconductor storage device incorporated in a computer system, for example. The above-mentioned program may be transmitted via a telecommunication line.

Although the embodiment of the present invention has been described in detail with reference to the drawings above, a specific configuration is not limited to this embodiment, and design within the scope of the gist of the present invention, and the like are included.

### Industrial Applicability

The present invention is applicable to a concentrator for receiving information from a plurality of transmission terminals.

### Reference Signs List

30 Concentrator
400 Feedback control unit
610 Stream identification unit
620 Scheduler identification unit
630 Arrival timing identification unit
640 First feedback unit
650 Second feedback unit
660 Instruction unit

1. A concentrator that receives streams transmitted from a plurality of transmission terminals, the concentrator comprising:
a processor; and
a storage medium having computer program instructions stored thereon, when executed by the processor, perform to:
derive transmission start timing in which the streams transmitted from the plurality of transmission terminals are grouped in advance and reception periods of a packet group included in the streams belonging to the group do not overlap in the group;
derive transmission start timing in which reception periods of packet groups transmitted at the transmission start timing derived do not overlap in different groups; and
instruct the transmission terminal on the transmission start timing derived.

2. The concentrator according to claim 1, wherein
the packet group is configured by packets having a packet interval transmitted in a stream equal to or less than a fixed time.

3. The concentrator according to claim 1, wherein the storage medium further has computer program instructions stored thereon, when executed by the processor, perform to:
recognize the packet group having the packet interval equal to or less than the fixed time for the respective received streams, acquire a time interval between two consecutive packet groups for the respective streams, and
estimate the reception period of a future packet group for the respective streams on the basis of the recognized packet group and the time interval.

4. A communication system comprising a plurality of transmission terminals and a concentrator that receives streams transmitted from the transmission terminals, wherein
the concentrator comprises:
a processor; and
a storage medium having computer program instructions stored thereon, when executed by the processor, perform to:
derive transmission start timing in which the streams transmitted from the plurality of transmission terminals are grouped in advance and reception periods of a packet group included in the streams belonging to the group do not overlap in the group,
a derive transmission start timing in which reception periods of packet groups transmitted at the transmission start timing derived do not overlap in different groups, and
instruct the transmission terminal on the transmission start timing derived, and
the transmission terminal starts transmission at the transmission start timing instructed.

5. A communication system comprising a concentrator that receives streams transmitted from a plurality of transmission terminals and a congestion control device, wherein
the congestion control device comprises:
a processor; and
a storage medium having computer program instructions stored thereon, when executed by the processor, perform to:
derive transmission start timing in which the streams transmitted from the plurality of transmission terminals and received by the concentrator are grouped in advance and reception periods of a packet group included in the streams belonging to the group do not overlap in the group,
derive transmission start timing in which reception periods of packet groups transmitted at the transmission start timing derived do not overlap in different groups, and
instruct the transmission terminal on the transmission start timing derived.

6. (canceled)

7. (canceled)

8. The concentrator according to claim 2, wherein
the storage medium further has computer program instructions stored thereon, when executed by the processor, perform to:
recognize the packet group having the packet interval equal to or less than the fixed time for the respective received streams, acquire a time interval between two consecutive packet groups for the respective streams, and estimate the reception period of a future packet group for the respective streams on the basis of the recognized packet group and the time interval.
